(19) United States
(12) Patent Application Publication
(10) Pub. No.: US 2004/0159175 A1
(43) Pub. Date: Aug. 19, 2004

(54) Gearshift handgrip for bicycle

(76) Inventor: Po-Cheng Chen, Taipei (TW)

Correspondence Address: Jason Z. Lin, Supreme Patent Services, Post Office Box 2339, Saratoga, CA, 95070-0339, US

(21) Appl. No.: 10/368,211

(22) Filed: Feb. 15, 2003

(51) Int. Cl. G05G 1/10

(52) U.S. Cl. 74/553

(57) ABSTRACT

A gearshift handgrip for bicycle is characterized in that a plurality of protruding dots or dimples is specifically arranged on the surface of the housing of a gearshift device adjacent to the handgrip, so that a rider can be aware of the gear position merely by touching the dots or dimples with fingers whenever a gearshift is desired.

### FIELD OF THE INVENTION

This invention relates to a gearshift handgrip for bicycle, which enables a bicycle rider to be aware of the gear position by touch.

### BACKGROUND OF THE INVENTION

No matter controlled by an automatic or a manipulative gearshift device, the basic principle for changing speed of a bicycle is to alter and control the relative position between the drive chain and the pedal chain-wheel set by adjusting the length of a speed-controlling cable (the more the gear tooth of the pedal chain wheel, the higher the speed of the rear wheel).

The gearshift device of a speed-variable bicycle in early days was usually disposed at a position far away from the handgrip, therefore, a rider has to move his/her one hand from the handlebar to operate the gearshift device whenever speed variation is desired. As this movement could entail imbalance or jittering on the bike to tilt or even topple it, the inventor of this invention, for eliminating the mentioned defects, has previously submitted a Taiwan patent application No. 89204539 entitled “Handgrip type gearshift device for bicycle” to the local authorities.

In the previous application, the gearshift device is located adjacent to the handgrip such that a rider can hold the handgrip and meanwhile tick off the gearshift device for adjusting the gear position. However, just like a fly in the ointment, a rider who lacks experience might be distracted from paying attention to the road situation at the moment when he is doing so by using the previous invention. This is especially dangerous when riding at a high speed in the event of a bike race, for example.

### SUMMARY OF THE INVENTION

The primary objective of this invention is to eliminate the defect of a conventional gearshift device, which might distract a bicycle rider to cause a traffic accident when he/she has to view on the gearshift device to shift the gear position.

In order to realize abovesaid objective, a plurality of protruding dots or dimples is specifically arranged on the surface of the housing of the gearshift device adjacent to the handgrip, so that a rider can be aware of the gear position by touching the dots or dimples with fingers whenever a gearshift is desired.

When compared with the structure of the conventional gearshift device, this invention can obviously provide an easier and safer operation for shifting the gear position by touching with fingers instead of viewing.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a three-dimensional view of this invention showing a plurality of protruding dots formed on the housing surface of a gearshift device;

FIG. 2 is a three-dimensional view of this invention showing a plurality of dimples formed on the housing surface of the gearshift device; and

FIG. 3 is a top plan view of this invention showing the plurality of dimples formed on the housing surface of the gearshift device.

### DETAILED DESCRIPTION OF THE INVENTION

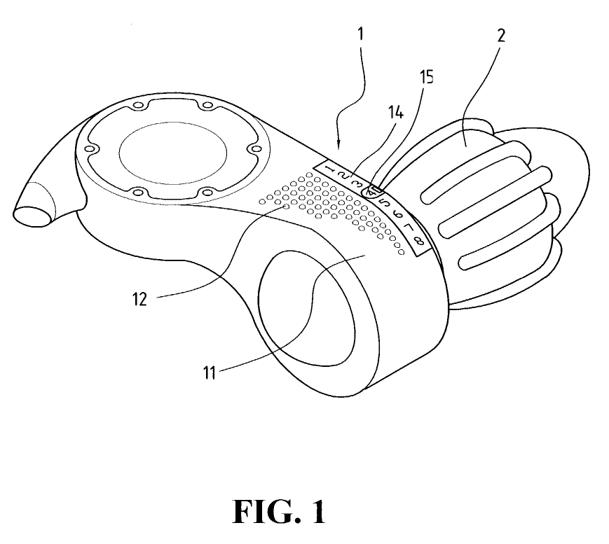

As shown in FIG. 1, this invention is constructed by disposing a gear-position display panel 14 laterally on the housing 11 of a gearshift device 1 and a handgrip 2 adjacent to one side of the gear-position display panel 14. On the gear-position display panel 14, a group of serial numerals including 1, 2, . . . all the way up to 8 representing different gear positions is marked sequentially from the front to the rear, and an index pointer 15 movable for pointing at the present working gear according to position switch of the gearshift device 1 is arranged. As the control structure of the index pointer 15 is related to the prior techniques and not a key point to be emphasized in this invention, hence it will not be reiterated here.

This invention is characterized in that a plurality of protruding dots 12 in rows is formed on the surface of the housing 11 of the gearshift device 1 and aligned in an manner where the more the row dot is given, the less the row order is arranged.

By means of dot's configuration, a rider can switch the gear position by either viewing the position of the index pointer 15 on the gear-position display panel 14 or touching the protruding dots 12 at the position corresponding to the index pointer 15 with fingers. In the latter case, the rider is informed of a low-speed gear position if he feels more dots in the row, and vice versa.

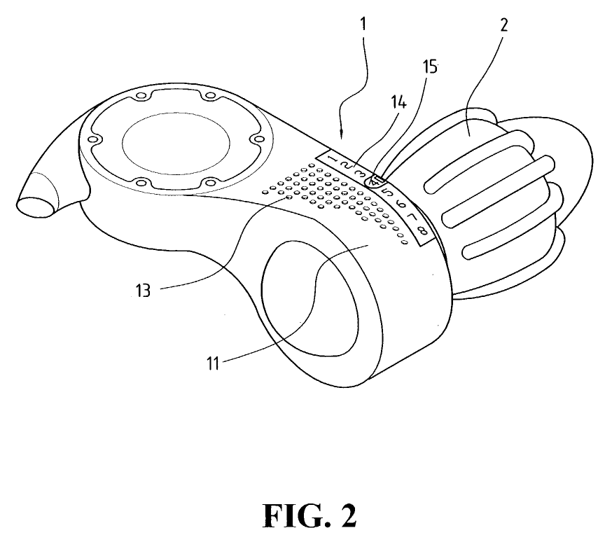

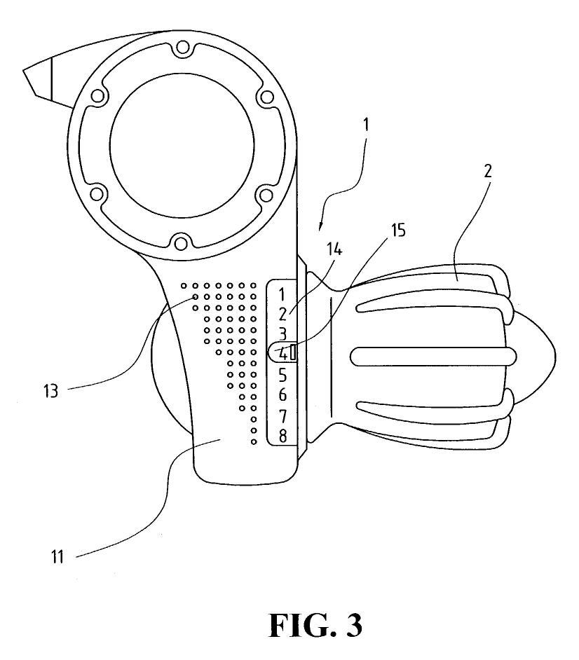

In another embodiment of this invention shown in FIGS. 2 and 3, the protruding dots 12 are substituted by dimples 13 aligned in the same manner.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A gearshift handgrip for bicycle, which is constructed by disposing:
a handgrip laterally on the housing of a gearshift device;
a gear-position display panel on the surface and adjacent to one side of the housing of the gearshift device; and
an index pointer on the gear-position display panel, movable according to gearshifts;
in which a plurality of protruding dots or dimples is formed on the surface of the housing of said gearshift device.

2. The gearshift handgrip according to claim 1, in which the more the row dot is given, the less the row order is arranged.
